(19) United States
(12) Patent Application Publication
(10) Pub. No.: US 2002/0089772 A1
(43) Pub. Date: Jul. 11, 2002

(54) Automation system with a work drive unit

(76) Inventors: Rupert Gall, Hetzles (DE); Thomas Hornfischer, Herzogenaurach (DE)

Correspondence Address: BAKER & BOTTS, 30 ROCKEFELLER PLAZA, NEW YORK, NY, 10112

(21) Appl. No.: 10/006,729

(22) Filed: Dec. 4, 2001

(30) Foreign Application Priority Data
Jan. 10, 2001 (DE) 101 00 937.2
Jul. 6, 2001 (DE) 101 32 809.5

(51) Int. Cl. G11B 15/12; G11B 5/09; G11B 5/02

(52) U.S. Cl. 360/61; 360/46; 360/25

(57) ABSTRACT

An automation system has a work drive unit (22), in which work programs (14, 16, 18, 20) and work data (15, 17, 19) are stored. It also has a back-up drive unit (12). By means of a back-up program (20), a back-up copy (23, 24) of at least part of the work programs (14, 16, 18,20) and work data (15, 17, 19) can be stored in the back-up drive unit (12). As a result, the part of the work programs (14, 16, 18, 20) and work data (15, 17, 19) can be restored again if required.

### FIELD OF THE INVENTION

The present invention relates to an automation system with a work drive unit, in which work programs and work data are stored.

### BACKGROUND OF THE INVENTION

Automation systems require a high degree of availability and fail-safe features, both with respect to hardware and software. This is particularly so whenever unusual operating states occur, such as the sudden switching-off or failure of the electrical power supply. Such an interruption of the electrical power supply is generally not problematical. However, in the case of PC-based automation systems with hard-disk operating systems, an inconsistent state of the operating system may occur in an individual case as a result of an interruption of the electrical power supply. The risk exists both during the system run-up and in the course of system operation. In an extreme case, a power interruption may lead to the system no longer being able to be run-up. In the event of such a serious defect, it is very important that, once the problem state has been rectified, the automation system continues to run with the same work data as before the interruption.

In the prior art, re-installation of the operating system and application programs, and restoration of the work data from an external back-up medium, for example a streamer, is known. However, said re-installation and restoration procedures are laborious and time-consuming.

### SUMMARY OF THE INVENTION

The object of the present invention is to provide an automation system by means of which a simple and rapid restoration of the work programs and the work data is possible in the event of a failure in this automation system. This object is achieved by utilizing a back-up drive unit in which a back-up copy of at least part of the work programs and work data are stored by means of a back-up program, thus enabling the work programs and work data to be restored.

The work programs usually comprise system programs and application programs and the work data usually comprise system data assigned to the system programs and application data assigned to the application programs. These programs and data are generally stored in different memory areas. If the system programs comprise the back-up program, the back-up program is also immediately available for rectifying a fault.

If the work drive unit has a system drive unit and an application drive unit, and if the system programs and the system data are stored in the system drive unit and the application programs and the application data are stored in the application drive unit, a separate back-up and restoration of system programs and system data on the one hand and application programs and application data on the other, is possible.

If the system drive unit has a main system drive unit and an auxiliary system drive unit, and an auxiliary operating system, wherein system data and the back-up program are stored in the auxiliary system drive unit, and a main operating system with its system data stored in the main system drive unit, it is ensured even in the case of “fault-susceptible” operating systems, such as Windows 95, Windows 98 or Windows NT, that after a fault it is always possible for the (robust) auxiliary operating system to be run-up, at least until the back-up program is called up, and after that for the main system drive unit to be restored.

If the drive units are logical drive units of a common physical drive unit, the automation system according to the invention can be realized in a spatially particularly compact form. If the back-up drive unit is dimensioned in such a way that at least two back-up copies can be stored in it, a second back-up copy can be written to the back-up drive unit without already overwriting the first back-up copy. It is therefore possible always to keep a correct, complete back-up copy in the back-up drive unit.

### BRIEF DESCRIPTION OF THE DRAWINGS

Further advantages and details of the present invention are disclosed in conjunction with an exemplary embodiment and drawings, in which:

FIG. 1 shows an automation system;

FIG. 2 shows a physical drive unit; and

FIG. 3 schematically shows the saving and restoring of programs and data.

### DETAILED DESCRIPTION OF THE INVENTION

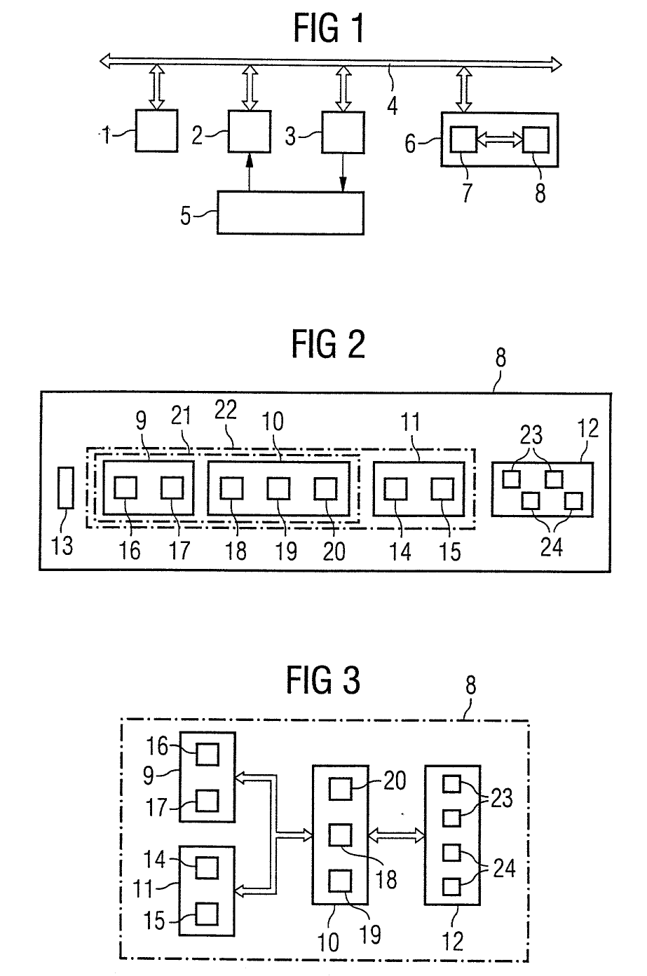

In FIG. 1, an automation system has a central processing unit 1, at least one input unit 2 and at least one output unit 3. The units 1 to 3 are connected to one another via a bus 4. States of an industrial technical installation 5 can be read into the central processing unit 1 via the input unit 2, and control commands to said central processing unit can be output via the output unit 3. The automation system according to FIG. 1 is PC-based. It consequently has a PC 6 with an arithmetic and logic unit 7 and a (physical) drive unit 8. The PC 6 is likewise connected to the central processing unit 1 via the bus 4.

In FIG. 2, the physical drive unit 8 is divided into four partitions or logical drive units 9 to 12. In a partitioning table 13 a record is kept of which memory locations of the physical drive unit 8 are assigned to which of the logical drive units 9 to 12. The logical drive units 9 to 12 form a main system drive unit 9, an auxiliary system drive unit 10, an application drive unit 11 and a back-up drive unit 12.

In the application drive unit 11, application programs 14 and application data 15 assigned to the latter are stored. In the main system drive unit 9, a main operating system 16 and its system data 17 are stored. In the auxiliary system drive unit 10, an auxiliary operating system 18, its system data 19 and a back-up program 20 are stored.

If the main operating system 16 is robust, i.e., there is only a very small risk of faults in the event of a sudden failure of the electrical power supply, the main system drive unit 9 and the auxiliary drive unit 10 may be combined along with the programs 16, 18, 20 and data 17, 19 stored in them to form a common system drive unit 21. This is indicated in FIG. 2 by a broken border around the drive units 9 and 10. Furthermore, it is possible also to combine the application programs 14 and the application data 15 together with the system programs 16, 18, 20 and the system data 17, 19 in a common work drive unit 22. This is also indicated in FIG. 2 by a broken border.

The division into separate drive units 9, 11 is of advantage, however, to the extent that back-up copies can then be created independently of one another. In principle, however, it is also possible to combine system programs 16, 18, 20 and application programs 14 to form work programs, to combine system data 17, 19 and application data 15 to form work data and to store all the programs 14, 16, 18, 20 and data 15, 17, 19 in the common work drive unit 22.

Generally speaking, when the automation system is run-up, the main operating system 16 is started. The main operating system 16 is, for example, a window-based user interface (Windows 95/98/NT). Alternatively, when the automation system is run up, the auxiliary operating system 18 may be started. The auxiliary operating system 18 is, for example, DOS. The back-up program 20 can be called up from the auxiliary operating system 18. The back-up program 20 is a commercially available back-up program 20, for example Norton Ghost from the Symatec company of Cupertino, Calif., USA.

It is possible by means of the back-up program 20 to store a system back-up copy 23 of the main operating system 16 and of the main system data 17 in the back-up drive unit 12. It is also similarly possible to create an application back-up copy 24 of the application programs 14 and of the application data 15 and store it in the back-up drive unit 12. According to FIG. 3, the back-up drive unit 12 is dimensioned in such a way that two of the back-up copies 23, 24 at a time can be stored in it.

In the case of a fault which has the result that the main operating system 16 or the application programs 14 can no longer be called up, it is generally at least possible to start the auxiliary operating system 18 and call up the back-up program 20 from there. In this case, the more up-to-date of the back-up copies 23, 24 are called up and the application programs 14 and the application data 15 or the main operating system 16 and the main system data 17 are restored again on the basis of the more up-to-date back-up copies 23, 24.

By means of the present invention, it is possible, even in the event of a fault, for the automation system to be run-up in a simple, and efficient way.

We claim:

1. An automation system comprising a work drive unit and a back-up drive unit, wherein work programs and work data are stored in the work drive unit, and further wherein a back-up copy of at least part of the work programs and work data are stored by means of a back-up program in the back-up drive unit, so that said part of the work programs and work data can be easily restored.

2. The automation system according to claim 1, wherein the work programs comprise system programs and application programs, and the work data comprise system data assigned to system programs and application data assigned to application programs.

3. The automation system according to claim 2, wherein the system programs comprise the back-up program.

4. The automation system according to claim 2, wherein the work drive unit has a system drive unit and an application drive unit, and the system programs and the system data are stored in the system drive unit, and the application programs and the application data are stored in the application drive unit.

5. The automation system according to claim 4, wherein the system drive unit has a main system drive unit and an auxiliary system drive unit, and further wherein an auxiliary operating system, its systems data and back-up program are stored in the auxiliary drive unit, and a main operating system and its system data are stored in the main system drive unit.

6. The automation system according to claim 1, wherein the drive units are logical drive units of a common physical drive unit.

7. The automation system according to claim 1, wherein the back-up drive unit is able to store at least two back-up copies.
